(19) United States
(12) Patent Application Publication
(10) Pub. No.: US 2008/0248942 A1
(43) Pub. Date: Oct. 9, 2008

(54) Porous phosphorous glass compositions

(76) Inventors: Nicholas F. Borrelli, Elmira, NY (US); George B. Hares, Corning, NY (US); Joseph F. Schroeder, Corning, NY (US)

Correspondence Address: CORNING INCORPORATED, SP-TI-3-1, CORNING, NY, 14831, US

(21) Appl. No.: 12/080,530

(22) Filed: Apr. 3, 2008

Related U.S. Application Data
(60) Provisional application No. 60/921,666, filed on Apr. 3, 2007.

(51) Int. Cl. C03C 3/097; C03C 3/064; C03C 3/062

(52) U.S. Cl. 501/63; 501/77; 501/73

(57) ABSTRACT

A porous phosphorous glass composition, as calculated in weight percent on an oxide basis, including, for example: about 30-60 SiO₂; about 2-25 P₂O₅; about 0-5 B₂O₃; about 20-50 Al₂O₃; about 0.01-20 Na₂O; and about 0-20 K₂O, the composition having porosity and pore size properties as defined herein. The disclosure also provides a method for making porous phosphorous glass compositions.

### CLAIMING BENEFIT OF PRIOR FILED U.S. APPLICATION

This application claims the benefit of U.S. Provisional Application Ser. No. 60/921,666, filed on Apr. 3, 2007. The contents of this document and the entire disclosure of any publications, patents, or patent documents mentioned herein are incorporated by reference herein.

### BACKGROUND

The disclosure relates generally to porous glass compositions, and to methods for their making and their use.

“Thirsty Glass” is a moniker given to porous glass products, such as Vycor® commercially available from Corning Incorporated. The porous glass can be prepared by separating a borosilicate glass into two contiguous phases by heating. One phase is mainly silica, SiO₂, and the second phase is mainly borate, B₂O₃. The borate rich phase can be leached out by, for example, a dilute acid or base solution. The pores can be, for example, from about 40 Å to about 100 Å in diameter. Porous glass products have many applications; see for example, U.S. Pat. No. 4,245,506, which mentions a porous membrane humidity sensor.

The chemical activity of porous glasses has been attributed to the numerous and highly accessible surface hydroxyl groups, such as silanols (Si—OH) and like groups. Challenges for porous glasses are, for example, enhanced physical and chemical properties, such as greater chemical activity for instance greater acidity, ion exchange capacity, lower solubility, greater porosity, greater durability, and like properties.

There remains a need for high porosity glass compositions, and methods for their manufacture which overcome challenges of available porous glasses.

### SUMMARY

In general terms, the claimed invention relates to a glass composition having a high phosphorous oxide content and high porosity, and a method for making the glass composition.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Open celled porous glasses, having the desirable properties of fused silica, have been applied for various uses. Such glasses are produced by a process that avoids the need for high temperatures in melting and forming, which affords manufacturing cost savings. According to a conventional process, a relatively soft alkali borosilicate glass preform is melted in a conventional manner and is then pressed, drawn, or blown into the desired shape by standard processes used in glass production. The resulting work piece, which can optionally be given additional finishing operations, is subjected to a heat treatment above the annealing point but below the temperature that would produce deformation of the glass. Two continuous closely intermingled glassy phases are produced during the heat treatment. One phase, which is rich in alkali and boric oxide, is readily soluble with, for example, acid. The other phase, which is rich in silica, is insoluble. After the work piece is immersed in a hot dilute acid solution, the soluble phase is dissolved, leaving behind a fine, porous, high-silica lattice or spider-web-like shell (e.g., 96% wt silica). The resulting porous silica article is commonly known as thirsty glass (commercially known as Vycor® 7930, by Corning Inc.).

Porous glasses, like Vycor®, are mechanically strong, hard, non-flaking, and chemically inert. The open network permits selective permeability. Pore size in the glass varies, generally ranging from about 40 to about 200 Å, but are preferably used from 40 Å to 60 Å or 70 Å. Pore size distribution in a piece of glass is typically very narrow (+/−0.3 Å from average pore radius). The pore size may be adjusted as desired, for example, by dissolving the glass with a weakly reactive fluorine-containing compound. See generally, T. H. Elmer, “Porous and Reconstructed Glasses,” ENGINEERED MATERIALS HANDBOOK, Vol. 4, Ceramics and Glasses, pp. 427 32, ASM International (1992).

Due to its porosity, a material like Vycor® has an internal surface area of approximately 250 square meters per gram. A Vycor® 1×3 inch glass slide weighing approximately 3 gms has about 7.5 million cm² of surface area (alternatively, 2.5 million cm²/cm²). Comparatively, a non-porous glass slide of the same dimensions has only about 40 cm² of surface area—a difference of a factor of 200,000 for biomolecule attachment. Alternatively, the porous substrate can be characterized as having a plurality of interconnected voids of a predetermined mean size of about 40 Å or 50 Å dispersed there through, and having void channels that extend through to a top surface of the porous substrate. U.S. Pat. No. 6,994,972, to Bardhan, et al., assigned to Corning Incorporated, mentions the use of such a porous glass slide as a substrate for immobilizing biomolecules, in particular DNA.

In embodiments the disclosure provides a glass composition having a substantial amount of a source of P₂O₅ replacing, or in place of, silica, as found, for example, in the porous Vycor® glasses.

In embodiments the disclosure provides a glass composition having high porosity and high phosphorous content.

In embodiments the disclosure provides a porous phosphorous-containing glass composition comprising:

SiO₂ of from about 30 to about 60 weight percent;

P₂O₅ of from about 2 to about 25 weight percent;

B₂O₃ of from about 0 to about 5 weight percent;

Al₂O₃ of from about 20 to about 50 weight percent;

Na₂O of from about 0.01 to about 20 weight percent; and

K₂O of from about 0 to about 20 weight percent based on the total weight of the composition. The total weight of the composition refers to, for example, measured amounts or estimated amounts of initial ingredients used in forming melts, or measured or estimated amounts determined after melting, after heat treating, after leaching, after rinsing, or like steps or treatments. In embodiments the composition can have, for example, a % porosity of from about 5 to about 30, and have a mean pore size of from about 4 to about 10 nanometers.

In embodiments the composition can have, for example,

SiO₂ from about 40 to about 60 weight percent;

P₂O₅ from about 4 to about 20 weight percent;

B₂O₃ from about 1 to about 5 weight percent;

Al₂O₃ from about 20 to about 45 weight percent

Na₂O from about 0.01 to about 15 weight percent; and

K₂O from about 0 to about 10 weight percent.

In embodiments the composition can have, for example, a % porosity of from about 8 to about 28, and have a mean pore size of from about 5 to about 9 nanometers.

In embodiments the starting materials used to prepared the compositions of the disclosure can have a H₂O content of, for example, from about 1.0 to about 25 weight percent.

In embodiments the disclosure provides a method of making a porous phosphorous-containing glass comprising, for example:

melting ingredients comprising:
a source of SiO₂ from about 1 to about 40 weight percent,
a source of P₂O₅ from about 5 to about 30 weight percent,
a source of B₂O₃ from about 20 to about 25 weight percent,
a source of Na₂O from about 0.01 to about 10 weight percent,
a source of Al₂O₃ from about 6 to about 25 weight percent,
a source of K₂O from about 0 to about 10 weight percent, and
optionally a source of H₂O from about 0.01 to about 25 weight percent;

if, after cooling, the melt has not phase-separated into a silica-rich phase and borate-rich phase, then heat treating the resulting cooled melt to phase-separate the mixture; and

heating the phase-separated glass in water to dissolve the borate-rich phase. Phase-separation can be determined after-the-fact by, for example, whether the green glass can be leached with water to remove a boron-rich phase, such as by measuring and comparing the amount of boron or borate in the glass before and after leaching.

In embodiments the method can be accomplished by melting a mixture of the recited ingredients at, for example, from about 1,400 to about 1,500° C. for about 1 to about 60 minutes.

In embodiments the method can be accomplished by heat treating the resulting cooled melt to phase-separate the mixture, for example, at from about 475° C. to about 650° C. for about 1 to about 180 minutes, and illustrated and demonstrated herein.

In embodiments the method can be accomplished by heating the phase-separated glass in water to dissolve the borate-rich phase, for example, at from about 60 to about 100° C., at from about 75 to about 95° C., or at from about 75 to about 85° C., and then cooling to room temperature. Alternatively, the leaching step of the phase-separated glass in water to dissolve the borate-rich phase can be accomplished at even lower temperatures although the time to completion may be considerably longer, for example, from about 1 to 2 weeks compared to from about 1 to about 3 days. In embodiments the method can be accomplished by heating the phase-separated glass in water to dissolve the borate-rich phase, for example, in the absence of an added acid or free of an added acid, such as without dilute nitric acid, or like acids or acid mixtures. Accordingly, the glass composition and the method of making the glass of the disclosure are superior to other porous glasses since they can be readily produced using a mild water extraction or leaching step without the need for added strong or protic acids, at lower extraction or leaching temperatures, and shorter extraction periods.

In embodiments the disclosure provides a porous phosphorous containing glass composition prepared by the process as illustrated and demonstrated herein.

In embodiments the glass preparative method of the disclosure can be accomplished by equivalent variations on the abovementioned step or steps and by similar means which can avoid the disadvantages and higher costs associated with, for example, pore-former approaches or sol-gel methodologies for preparing porous glass.

In embodiments the disclosure provides for useful articles prepared with the disclosed glass compositions and modifications thereof, such as a structural glass member or glass body, such as a tube, a fiber, a fabric, a glass wool, a plate, a frit, a portion of another glass member, a container, and like articles or objects. Other useful articles prepared with the disclosed glass compositions and modifications thereof include, for example, a coating such as for an electrode, a passivation layer such as for integrated circuit devices, a catalyst, a catalyst substrate, an ion exchange media, a separation media for use for example in chromatography, an semi-permeable membrane, and like articles and applications. In embodiments the articles or devices prepared with the glass compositions of the disclosure can be transparent, translucent, or opaque. In embodiments, glass compositions of the disclosure can be opalescent or clear. In embodiments, preferred glass compositions of the disclosure are transparent, such as where high optical clarity, low optical interference, or like considerations, are desired.

For additional definitions, descriptions, and methods of silica (silicon dioxide, SiO₂) materials and related metal oxide materials as used herein, see for example, R. K. Iler, The Chemistry of Silica, Wiley-Interscience, 1979.

Abbreviations, which are well known to one of ordinary skill in the art, may be used (e.g., “h” for hour or hours, “g” or “gm” for gram(s), “mL” for milliliters, and “rt” for room temperature, “nm” for nanometers, and like abbreviations).

“Include,” “includes,” or like terms means including but not limited to.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. Whether modified by the term “about” the claims appended hereto include equivalents to these quantities.

“Consisting essentially of” in embodiments refers, for example, to a single compound, mixture of compounds, formulation, or a composition, the method of making or using a compound, formulation, or composition of porous glass compositions having high phosphorous oxide content, and articles or devices of the disclosure, and can include the components or steps listed in the claim, plus other components or steps that do not materially affect the basic and novel properties of the compounds, articles, and methods of use of the disclosure, such as particular reactants, particular additives or ingredients, a particular metal oxide or mixed metal oxide, or like structure, material, or process variables selected. Items that may materially affect the basic properties of the components or steps of the disclosure or may impart undesirable characteristics to the present disclosure include, for example, decreased porosity of the glass, decreased pore size of the glass, decreased transparency of the glass, increased water solubility of the glass, decrease mechanical integrity, and like characteristics. In embodiments, the porous glass compositions, the articles or devices, and the methods of the present disclosure preferably eliminate or avoid such undesirable characteristics. Thus, the claimed invention may suitably comprise, consist of, or consist essentially of: a porous phosphorous-containing glass composition as defined herein; an article or device as defined herein that includes the aforementioned composition; or a method of making the porous glass composition as defined herein.

In embodiments, the porous glass compositions, and the articles prepared from the porous glass compositions of the disclosure can have unexpected and surprisingly low solubility in water compared to other porous glasses or non-porous phosphorous containing glass.

The indefinite article “a” or “an” and its corresponding definite article “the” as used herein means at least one, or one or more, unless specified otherwise.

Specific and preferred values listed below for reactants, ingredients, additives, and ranges thereof, are for illustration only; they do not exclude other defined values or other values within defined ranges. The compositions of the disclosure and like compositions include those having any combination of the values, specific values, more specific values, and preferred values described herein.

The specific compositions or ingredients used in the preparation of the specific compositions of the disclosure, and like compositions, can include suitable salt or salts thereof or as illustrated herein. The starting materials employed in the methods described herein are commercially available, have been reported in the literature, or can be prepared from readily available starting materials using procedures known in the field. In embodiment, relative proportions of the reactants can be varied depending on properties desired in the resulting glass composition products, such as porosity, density, surface area, and like properties. Other similar porous glasses in which a portion of the silica, the alumina, or both, are partially replaced or substituted by phosphorous or a phosphorous oxide equivalent, can be prepared by the disclosed methods.

In embodiments the disclosure provides a glass composition and method that introduces phosphorous into a base glass composition, for example in the form of a phosphorous oxide, such as phosphorous pentoxide (P₂O₅), to obtain a porous glass having substantial phosphorous content. Useful activity and reactivity of commercially available porous Vycor® glass is believed to be mediated through its surface hydroxyl groups (—O—H), such as in the form of silanols of the formula ≡Si—OH. The introduction of a substantial phosphorous content to the glass composition, by for example addition or substitution, is expected to significantly increase the number of phosphorous bearing surface hydroxyl groups (P—OH), such as in the form of —P(═O)(—OH)—, —P(═O)(—OH)₂, and like forms or groups.

In embodiments, a number of approaches can be used to introduce the phosphorous into the glass composition. One approach comprises the substitution of compositional components of a known glass, for example, silicon (Si) as silica (SiO₂), boron (B) as borate (B₂O₃), aluminum (Al) as alumina (Al₂O₃), or like glass constituents, and combinations thereof by phosphorous. This approach can be accomplished by reducing one or more ingredients in the starting material and replacing the reduced ingredient(s) by an equivalent amount, such as in weight percent, mole percent, cation percent, or like measures, with a phosphorous compound. See for example the working Examples.

Another approach comprises the substitution of one or more compositional components of a known glass, such as the above mentioned component, or combinations thereof by phosphorous and at least one other components such as boron or aluminum. In embodiments, an excellent result was obtained when equal amounts, on a cation percent basis, of Al and P were substituted for Si in the glass melt composition. See for example the working Examples, samples OVH and OVK, where phosphorous and aluminum are substituted in place of silicon.

In embodiments, an excellent result was obtained when the initial or melt boron (B) content, for example, as measured by the borate (B₂O₃) content, was maintained at a constant concentration among compositional variants, such as from about 20 to about 40 weight percent, from about 20 to about 30 weight percent, and from about 20 to about 25 weight percent. The borate content determines the amount and extent of the borate-rich phase in the melted glass composition. The borate content is substantially, if not exclusively, concentrated in the borate-rich phase and determines the extent of the porosity and surface area in the residual glass after the borate-rich phase has been leached from the initial glass melt composition.

Another compositional approach to increase the amount of phosphorous in the glass melt comprises the substitution of potassium for sodium on a cation basis. The substitution of potassium for sodium apparently discouraged or prevented the formation of a sodium borate phase in the annealed glass. Compare the tabulated compositions in Table 1 for sodium containing sample OVH to OVR with the no or essentially zero sodium samples 741II to 741IK.

Table 1 presents the results of the compositional analysis of “green glass” compositions, that is, as melted compositions of combined ingredients, and prior to further heat treatment or leaching. These green glass compositions were subsequently processed into representative porous phosphorous glasses of the disclosure. Sample “VG” in Table 1 represents the comparative control sample composition for a green glass precursor sample for commercial porous Vycor® 7930 glass.

In all glass compositions analyzed, the As₂O₃ was 0.17 wt %, the TiO₂ was 0 to 0.01 wt %, and the SO₃ and chloride ion (Cl⁻) were 0.0 wt %, and are not included in Table 1 for clarity.

TABLE 1
Representative Green Glass Compositions in Weight Percents
(Wt %)

| Composition | VG | | | | |
|---|---|---|---|---|---|
| (Wt %) | (Control) | OVH | OVI | OVJ | OVK |
| SiO₂ | 59.75 | 33.76 | 20.84 | 7.96 | 46.73 |
| Na₂O | 7.72 | 7.69 | 7.67 | 7.66 | 7.7 |
| Al₂O₃ | 2.31 | 13.23 | 18.66 | 24.08 | 7.78 |
| B₂O₃ | 29.97 | 29.86 | 29.81 | 29.76 | 29.92 |
| CaO | 0.02 | 0.01 | 0.01 | 0.01 | 0.01 |
| Fe₂O₃ | 0.01 | 0.01 | 0 | 0 | 0.01 |
| P₂O₅ | 0 | 15.22 | 22.79 | 30.33 | 7.63 |
| K₂O | 0 | 0 | 0 | 0 | 0 |

| Composition | | | | | | |
|---|---|---|---|---|---|---|
| (Wt %) | OVN | OVO | OVP | OVQ | OVR | OVS |
| SiO₂ | 40.24 | 27.30 | 26.55 | 20.49 | 14.26 | 13.98 |
| Na₂O | 7.69 | 7.68 | 7.47 | 7.54 | 3.80 | 0 |
| Al₂O₃ | 10.51 | 15.95 | 18.17 | 23.71 | 23.88 | 23.41 |
| B₂O₃ | 29.89 | 29.84 | 25.39 | 25.63 | 29.51 | 28.93 |
| CaO | 0.01 | 0.01 | 0.01 | 0.01 | 0 | 0 |
| Fe₂O₃ | 0.01 | 0.01 | 0.01 | 0 | 0 | 0 |
| P₂O₅ | 11.43 | 19.01 | 22.19 | 22.41 | 22.56 | 22.12 |
| K₂O | 0 | 0 | 0 | 0 | 5.79 | 11.35 |

| Composition | | | |
|---|---|---|---|
| (Wt %) | 741II | 741IJ | 741IK |
| SiO₂ | 13.97 | 7.72 | 1.50 |
| Na₂O | 0.08 | 0.07 | 0.07 |
| Al₂O₃ | 23.39 | 26.01 | 28.63 |
| B₂O₃ | 28.91 | 28.88 | 28.85 |
| Fe₂O₃ | 0 | 0 | 0 |
| P₂O₅ | 22.10 | 25.76 | 29.41 |
| K₂O | 11.34 | 11.33 | 11.32 |

Tables 2 and 3 present the results of compositional and physical analysis of residual (and comparative) representative porous phosphorous glasses of the disclosure.

Glass compositions were selected from Table 1, and processed with or without heat treatment (HT=heat treatment; no HT=no additional heat treatment), followed by leaching, and as indicated in accompanying Table 2. The leached samples were analyzed by ICP/DCP for the indicated analyte element (B, P, and Si) and are reported in weight percent of the indicated oxides (B₂O₃, P₂O₅, and SiO₂) for each sample based on the total weight of the sample.

TABLE 2
Analysis of Selected Porous Glasses in Weight Percent After Leaching

| | B₂O₃ | | P₂O₅ | | SiO₂ | |
|---|---|---|---|---|---|---|
| GLASS | In Wt % | | In Wt % | | In Wt % | |
| VYCOR ® | <4 | (30)¹ | 0 | (0)¹ | 96 | (60)¹ |
| OVK* | 2.1 | (30) | 4.9 | (8) | 58 | (47) |
| OVH* | 4 | (30) | 17 | (15) | 45 | (34) |
| OVN | 2.5 | (30) | 12.5 | (11) | 56 | (40) |
| OVN (HT)² | 3.9 | | 12.5 | | 56.3 | |
| OVO | —³ | (30) | — | (19) | — | (27) |
| OVP | — | (25) | — | (22) | — | (27) |
| OVS (HT) | 0.25 | (29) | 29 | (22) | 22 | (14) |
| 741 II | 0.24 | (29) | 33 | (22) | 21 | (14) |

¹Parenthetic values are for the glasses prior to leaching
²HT = heat treatment
³“—” = not measured
*The original glass melt also contained Na₂O and Al₂O₃, and is assumed to be substantially retained in the residual glass following leaching.

In Table 3 the wt % P₂O₅ value shows the weight percent of phosphorous pentoxide in the glass melt. The % porosity value represents the volume percentage of porosity in the glass sample, that is the final or leached glass sample, as measured by mercury porosimetry, and is also a representative measure of void space in the bulk volume. For example, % porosity of about 10 equates to about 10% void space or void volume in the bulk glass. Similarly, a 30% porosity equates to about 30% void space or void volume in the bulk glass. The Avg Pore Size value (in nanometers) represents the average or arithmetic mean pore size also as measured by mercury porosimetry methods. The Vycor® sample represents a comparative glass analysis for commercial Vycor® 7930.

TABLE 3
Calculated Values of Selected Porous Glasses After Leaching

| | | | Avg Pore Size |
|---|---|---|---|
| GLASS | Wt % P₂O₅ | % porosity | (nm) |
| Vycor ® | 0 | 28.8 | 4.5 |
| OVK(HT) | 8 | 16.8 | 5.2 |
| OVK(annealed) | 8 | 8.7 | 8.6 |
| OVH(annealed) | 15 | 26 | 6 |
| OVN(annealed) | 11 | 21 | 5.6 |
| OVN(HT) | 11 | 17.1 | 5 |
| OVS(HT) | 22 | 23 | 5.9 |
| 741 II(K-sub) | 22 | 23 | 5.2 |

HT = heat treatment prior to leaching
annealed = no additional heat treatment prior to leaching
K-sub = potassium for sodium substituted sample

### EXAMPLES

The following examples serve to more fully describe the manner of using the above-described disclosure, as well as to further set forth the best modes contemplated for carrying out various aspects of the disclosure. These examples in no way limit the true scope of this disclosure, but rather are presented for illustrative purposes.

### Comparative Example

PREPARATION OF Vycor® Commercially available porous Vycor® can be prepared as follows. The ingredients are combined and melted, and then formed into blanks. The measured Vycor® composition is given as the “VG” entry in Table 1. The glass is then subjected to a heat treatment, such as listed below, which produces a liquid-liquid phase separation.

The following lists an illustrative comparative example of a heat treatment (HT) schedule or procedure used to process a one-half inch thick production rolled sheet of Vycor®.

| Operation | Hours |
|---|---|
| Heat from 100 to 200° C. at 260° C./hr | 0.38 |
| Heat from 200 to 335° C. at 160° C./hr | 0.85 |
| Heat from 335 to 550° C. at 105° C./hr | 2.05 |
| Heat from 550 to 600° C. at 60° C./hr | 0.83 |
| Hold at 600° C. for 3.5 hr | 3.5 |
| Cool from 600 to 565° C. at 30° C./hr | 1.17 |
| Cool from 565 to 350° C. at 30° C./hr | 7.17 |
| When furnace starts to lag, power turned-off | |
| Cooling vent opens at 565° C. | |
| Open door at 250° C. | |
| Leave fan on for a minimum 60 min; then unload | |
| Total Time (hrs) | 15.95 |

The resulting product consists of a first borate-rich phase and a second silica-rich phase. The phase-separated borate-rich phase is very finely dispersed and continuous throughout the matrix of the silica-rich phase. The borate-rich phase is soluble in dilute nitric acid. Contacting the phase-separated glass composition with dilute nitric acid separated or leached-out the borate-rich phase and left behind the silica-rich phase as a highly porous interconnected structure having an opalescent appearance.

### Example 1

PREPARATION OF GLASS MELTS Test samples were prepared by combining and thoroughly mixing the commercially available major ingredients as listed in Table 1. Minor ingredients, such as less than or equal to 0.01, listed in Table 1 are present for trace analysis control only and are not added to the initial ingredient mix. The resulting mixtures were separately melted and the resulting glass melts were formed into blanks. The glass melt blanks are optionally, if not already phase separated as a result of the melting, subjected to a heat treatment described below which produces the desired liquid-liquid glass phase separation to produce an intermediate product having a silica-rich phase and a borate-rich phase. The borate-rich phase is very finely dispersed and continuous throughout the matrix of the silica-rich phase.

### Example 2

HEAT TREATMENT PROCESS TO EFFECT PHASE SEPARATION Each experimental melt glass was subjected to a modified (exceptions being noted below) heat treatment schedule as used in Vycor® manufacture mentioned above to effect the silica and borate phase-separation. In some instances the glass melts appeared phase-separated in the annealed state, that is, occasionally glass samples showed phase separation after the annealing. In those annealed phase-separated instances no additional heat treatment was used. See Table 1 compositions, for example, the 741 samples, and the OVH and OVO samples which did not receive additional heat treatment.

The two examples below are heat treatment schedules (HTS) or procedures that were modeled after the above Vycor® schedule with particulars indicated. These modified schedules were used to process the annealed (phase separation occurred during annealing; about 500° C.) glass samples of high porosity phosphorous containing glass of the disclosure. In HTS-1 (“Vycor565-3 hr”), samples were heated to 565° C., and then held for 3 hr before cooling to room temperature (RT). Similarly, in HTS-2 (“Vycor525-3 hr”), samples were heated to 525° C., and then held for 3 hr, before cooling to room temperature (RT).

| | |
|---|---|
| Operation | Hours:Minutes |

HTS-1

| | |
|---|---|
| RT to 565° C. | 18:10 |
| 565° C. hold | 3 |
| Hold to RT | 6:03 |
| Total Time (hrs) | 27:13 |

HTS-2

| | |
|---|---|
| RT to 525° C. | 18:10 |
| 525° C. hold | 3 |
| Hold to RT | 9 |
| Total Time (hrs) | 30:10 |

### Example 3

WATER-BASED ACID-FREE LEACHING PROCESS The phase-separated glass samples, annealed (as made) or as phase-separated as described in Example 2, were unexpectedly noted by visual observation to be slightly water soluble, so that the leaching treatment was attempted and successfully accomplished in water at 80° C. in about 3 days (instead of the dilute HNO₃ bath at 92° C. as may be used for example in commercial Vycor® manufacture). Alternatively, the leaching treatment was also successfully accomplished in water at ambient temperature for 1 week. The water leaching step produced the desired porous structure. The residual glass, that is after leaching and removal of the borate-rich phase with water, was not water soluble. Thus the phase-separated glass compositions of the disclosure dissolve or leach-out the borate-rich phase when subjected to warm water treatment and leave behind the silica-rich phosphorous containing phase as a highly porous interconnected structure.

The acid-free leaching procedure was accomplished as follows:

glass samples for leaching were placed in deionized water saturated with or without Cabosil (a synthetic, amorphous, untreated fumed silica product) present; the glass samples in the water/Cabosil suspension (silica slurry) were heated in the water bath maintained at about 80° C. for about 24 to about 36 hrs;

the glass samples were removed from the water/Cabosil suspension and placed in a heated (80° C.) deionized water wash for about 12 hrs;

the glass samples were removed from the water bath and slowly cooled to ambient temperature.

The Cabosil is believed to maintain the equilibrium concentration of silica in the bath during processing. The Cabosil is substantially or entirely removed from the glass by washing, and is not believed to be incorporated into the finished glass in significant quantities.

The disclosure has been described with reference to various specific embodiments and techniques. However, it should be understood that many variations and modifications are possible while remaining within the spirit and scope of the disclosure.

What is claimed is:

1. A porous phosphorous-containing glass composition, in weight percent on an oxide basis, comprising:
SiO₂ of from about 30 to about 60;
P₂O₅ of from about 2 to about 25;
B₂O₃ of from about 0 to about 5;
Al₂O₃ of from about 20 to about 50;
Na₂O of from about 0.01 to about 20; and
K₂O of from about 0 to about 20,
the composition having a % porosity of from about 5 to about 30, and having an average pore size of from about 4 to about 10 nanometers.

2. The composition of claim 1 wherein
SiO₂ is from about 40 to about 60;
P₂O₅ is from about 4 to about 20;
B₂O₃ is from about 1 to about 5;
Al₂O₃ is from about 20 to about 45;
Na₂O is from about 0.01 to about 15; and
K₂O is from about 0 to about 10 weight percent,
the composition having a % porosity of from about 8 to about 28, and having an average pore size of from about 5 to about 9 nanometers.

3. A method of making a porous phosphorous glass comprising:
melting ingredients, in weight percent on an oxide basis, comprising:
a source of SiO₂ from about 1 to about 40,
a source of P₂O₅ from about 5 to about 30,
a source of B₂O₃ from about 20 to about 25,
a source of Al₂O₃ from about 6 to about 25,
a source of Na₂O from about 0.01 to about 10, and
a source of K₂O from about 0 to about 10;
if the melt, after cooling, has not phase-separated into a silica-rich phase and borate-rich phase, then heat treating the resulting cooled melt to phase-separate the mixture; and
heating the phase-separated glass in water to dissolve the borate-rich phase

4. The method of claim 3 wherein melting is at from about 1,400 to about 1,500° C. for about 1 to about 60 minutes.

5. The method of claim 3 wherein heat treating is at from about 475° C. to about 650° C. for about 1 to about 180 minutes.

6. The method of claim 3 wherein heating the phase-separated glass in water is at from about 60 to about 100° C. for about 1 to about 7 days.

7. The method of claim 3 wherein heating the phase-separated glass in water is at from about 75 to about 90° C. for about 3 to about 7 days.

8. The method of claim 3 wherein heating the phase-separated glass in water is accomplished free of an added acid.

9. The method of claim 3 wherein heating the phase-separated glass in water is accomplished including a silica slurry.

10. A porous aluminum silicophosphate glass composition, in weight percent on an oxide basis, comprising:
SiO₂ of about 30 to about 60;
P₂O₅ of about 2 to about 25;
Al₂O₃ of about 20 to about 50;
B₂O₃ of about 0 to about 5; and
Na₂O of about 0.01 to about 20,
the composition having a porosity of from about 5 to about 30%, and an average pore size of from about 4 to about 10 nanometers.

11. The glass composition of claim 10 further comprising K₂O of about 0.1 to about 20 weight percent.

12. A porous phosphorous-containing glass composition prepared by the process of claim 3.

13. The method of claim 3 further comprising a source of water from about 10 to about 25, in weight percent on an oxide basis, as an addition or a superaddition.

14. The method of claim 3 further comprising a source of water from about 1 to about 5, in weight percent on an oxide basis, as an addition or a superaddition.
